(19) United States
(12) Patent Application Publication
(10) Pub. No.: US 2004/0101630 A1
(43) Pub. Date: May 27, 2004

(54) Method of coating a substrate

(76) Inventors: Udo Wolfgang Buecher, Corrimal (AU); Mark John Davies, Albion Park Rail (AU)

Correspondence Address: John C Kerins, Miles & Stockbridge, Suite 500, 1751 Pinnacle Drive, McLean, VA, 22102-3833, US

(21) Appl. No.: 10/432,951

(22) PCT Filed: Dec. 1, 2000
(86) PCT No.: PCT/AU00/01488

(51) Int. Cl. B05D 1/28

(52) U.S. Cl. 427/428; 118/693; 118/694; 118/200; 118/258

(57) ABSTRACT

A method and an apparatus for forming a coating of a paint composition on a moveable substrate is disclosed. The method involves determining the volume flow rate of the paint composition that is required to form a desired wet film thickness for a given substrate speed and coating width and supplying the paint composition to a pool in the nip between an applicator roll and a metering roll or other suitable metering means at a flow rate that is substantially equal to the calculated flow rate, and then monitoring the level of the paint composition in the pool and adjusting operating parameters, such as the pressure between the rolls to maintain the paint composition level substantially constant. Maintaining a substantially constant level of the paint composition in the pool in a situation where the volume flow rate of the paint composition into the pool is substantially equal to that required to form the desired wet paint thickness on the substrate ensures that the required volume flow rate of the paint composition is being transferred from the pool to the substrate.

The present invention relates to a method and an apparatus for forming a coating of a polymer-based paint composition on a moving substrate.

The invention relates particularly, although by no means exclusively, to a method and an apparatus for forming a thin ornamental and/or protective coating of a polymer-based paint composition on a moving substrate that is in the form of a metal strip.

The term “thin” as used herein is understood to mean a coating thickness of up to 60 micron.

Typically, the invention is applicable to the production of pre-painted steel strip that is used as the starting material in the production of building cladding sheets and other steel metal products for the building industry, appliance cabinets, vehicle bodies and many other sheet metal products.

Ornamental and protective coatings are conventionally applied to steel strip, such as galvanised or ZINCALUME (Registered Trade Mark) coated coiled stock, by coating the strip with solvent-based (including water-based) paint compositions by means of a liquid paint applicator such as a roll coater or a curtain coater. Typically, the paint compositions include polymeric film-forming materials, pigments and inert fillers held in the solvent. The coated strip is then heated to remove solvent. If the film-forming polymeric material is of the thermoplastic type the removal of the solvent virtually completes the process. If the polymeric material is of the thermosetting type, a subsequent curing step is required to effect cross-linking which causes the film to harden.

One form of a conventional roll coater paint applicator includes a paint drum that stores a quantity of a paint composition and a pump that pumps the paint composition from the drum to a paint tray of a roll coater assembly. The coater assembly also includes a pick-up roll that is positioned so that a lower part of the roll is immersed in the paint composition in the tray, whereby the paint composition forms a film on the immersed roll surface and rotation of the roll carries the film from the tray. The coater assembly also includes an applicator roll that is positioned against the pick-up roll and forms a nip with the pick-up roll and is also positioned to contact a moving steel strip. The applicator roll rotates in the opposite direction to the pick-up roll whereby, when the paint film on the pick-up roll rotates to the nip, part of the film is transferred to the applicator roll surface moving through the nip at that time and is carried by the applicator roll to the steel strip and is at least partially transferred to the strip and thereby forms a coating on the strip. The procedure that has to be followed in order to initially set up the roll coater paint applicator to operate to form a coating having a desired dry paint film thickness is essentially based on selecting operating parameters on a best experience or operator know-how basis and operating the paint applicator and monitoring the coating thickness and adjusting the operating parameters using feedback from measured results of either wet or dry paint film thickness. The process may be repeated until the desired wet paint film thickness is achieved. The operating parameters include the speed of the pick-up roll, the speed of the applicator roll, the pressure between the rolls, the pressure between the applicator roll and the steel strip, and the steel strip speed. Other conditions which affect the set up of a roll coater paint applicator are applicator roll diameter and applicator roll hardness. This procedure is time consuming and results in wastage of the paint composition and wastage of steel strip. Often the method used to measure paint film thickness includes contacting the painted strip just after the coater using a wet film wheel. This is a destructive test resulting in waste coated strip. The operation of the roll coater paint applicator is also based on providing an excess of the paint composition to the paint tray so that there is always an ample supply of the paint composition to be taken up by the pick-up roll and there is circulation of the paint composition within the tray and between the tray and the paint drum. Consequently, the roll coater paint applicator also includes a return chute which returns paint composition from the tray to the drum. Operating with an excess of the paint composition results in paint wastage and time delays and costs associated with colour change over.

An object of the present invention is to provide an alternative method and apparatus for forming a coating of a polymer-based paint composition on a steel strip.

According to the present invention there is provided a method of forming a coating of a paint composition on a substrate which includes the steps of:

(a) moving the substrate past an applicator roll while maintaining contact between the applicator roll and the substrate and rotating the applicator roll so that the paint composition is carried by the applicator roll through a nip between the applicator roll and a metering means that is in contact with the applicator roll and into contact with the substrate and forms a coating on the substrate;

(b) supplying the paint composition in liquid form into a pool of the paint composition in the nip between the applicator roll and the metering means at a controlled volume flow rate that is substantially equal to the volume flow rate that is required to achieve a desired target wet paint film thickness on the substrate; and

(c) maintaining the level and hence the volume of the paint in the pool to be substantially constant.

Preferably the metering means is a metering roll.

In an alternative, although not the only alternative embodiment, the metering means is a metering blade.

According to the present invention there is also provided a method of forming a coating of a paint composition on a substrate which includes the steps of:

(a) moving the substrate past an applicator roll while maintaining contact between the applicator roll and the substrate and rotating at least the applicator roll and optionally rotating a metering roll that is in contact with the applicator roll so that the paint composition is carried by the applicator roll through a nip between the applicator roll and the metering roll and into contact with the substrate and forms a coating on the substrate;

(b) supplying the paint composition in liquid form into a pool of the paint composition in the nip between the rolls at a controlled volume flow rate that is substantially equal to the volume flow rate that is required to achieve a desired target wet paint film thickness on the substrate; and

(c) maintaining the level and hence the volume of the paint in the pool to be substantially constant.

The present invention is based on the realisation that a coating of a desired wet film thickness can be formed on a substrate in a method that involves determining the volume flow rate of the paint composition that is required to form a desired wet film thickness for a given substrate speed and coating width and supplying the paint composition to a pool in the nip between an applicator roll and a metering roll (or other suitable metering means) at a flow rate that is substantially equal to the calculated flow rate, and then monitoring the level of the paint composition in the pool and adjusting operating parameters, such as the pressure between the rolls, to maintain the paint composition level substantially constant. Maintaining a substantially constant level of the paint composition in the pool in a situation where the volume flow rate of the paint composition into the pool is substantially equal to that required to form the desired wet paint thickness on the substrate ensures that the required volume flow rate of the paint composition is being transferred from the pool to the substrate.

According to the present invention there is also provided a method of forming a coating of a paint composition on a substrate which includes the steps of:

(a) supplying the paint composition in liquid form to a nip between a metering roll and an applicator roll of a coater assembly and establishing a pool of the paint composition in the nip;

(b) prior to, during, or after step (a), bringing the applicator roll into contact with the substrate;

(c) moving the substrate past the applicator roll while maintaining contact between the applicator roll and the substrate and rotating at least the applicator roll and optionally the metering roll so that the paint composition is carried by the applicator roll through the nip between the rolls and into contact with the substrate and forms a coating on the contact surface of the substrate;

(d) as the paint composition is being removed from the pool by step (c) supplying the paint composition in liquid form into the pool at a controlled volume flow rate that is substantially equal to the volume flow rate required to achieve a desired target wet paint film thickness on the substrate taking into consideration the strip width, and the strip speed; and

(e) adjusting any one or more of the substrate speed, the surface speed of the applicator roll, the surface speed of the metering roll, the substrate speed, the contact pressure between the applicator roll and the substrate, and the contact pressure between the applicator roll and the metering roll to maintain the level and hence the volume of the paint in the pool to be substantially constant.

The reference in the above statements of invention to the volume flow rate of the paint composition into the pool being “substantially equal” to the volume flow rate required to achieve the desired target wet paint film thickness is understood herein to mean that the flow rate of the paint composition into the pool is the total of the flow rate of the paint composition that forms the coating on the substrate and an allowance for paint which may be lost by leakage from either or both of the metering roll or the applicator roll, generally beyond the edges of the substrate.

In one embodiment, the step of rotating the applicator roll and optimally the metering roll includes rotating the applicator roll and the metering roll so that the applicator roll carries the paint composition into contact with the substrate in a direction that is opposite to the direction of movement of the substrate.

In another embodiment, the step of rotating the applicator roll and optimally the metering roll includes rotating the applicator roll and the metering roll so that the applicator roll carries the paint composition into contact with the substrate in the same direction as the direction of movement of the substrate.

Preferably the metering roll and the applicator roll are driven at controlled speeds.

Preferably the method includes controlling the maximum surface speed of the metering roll expressed as a percentage of the speed of the applicator roll to be a linear relationship with the applicator roll speed so that the surface speed of the metering roll is no more than 1.2% of the applicator roll speed at an exemplary low applicator roll speed of 15 meters per minute and no more than 12% of the applicator roll speed at an exemplary applicator roll speed of 150 meters per minute.

Preferably the method includes controlling the maximum surface speed of the metering roll expressed as a percentage of the applicator roll speed to be less than 1% of the applicator roll speed.

Preferably the method includes controlling the speed differential between the metering roll and the applicator roll to ensure that the paint composition carried by the metering roll from the pool constitutes a film on the metering roll having an average thickness of no more than two microns.

Preferably the substrate is a metal strip, more preferably a steel strip, to be painted.

Preferably the method includes positioning side dams in relation to the applicator roll and the metering roll to confine the pool.

According to the present invention there is also provided an apparatus for forming a coating of a paint composition on a substrate in accordance with the method described above, which apparatus includes:

(a) a roll coater assembly which includes:

(i) an applicator roll mounted to contact the substrate;

(ii) a metering means mounted in relation to the applicator roll to form a nip with the applicator roll;

(iii) a means for applying pressure to the applicator roll and the metering means to maintain the roll and the metering means in contact at the nip;

(b) a means for supplying the paint composition to a pool of the paint composition that is confined at least in part by the nip between the applicator roll and the metering means at a volume flow rate that is substantially the same volume flow rate as that required to form a coating of a desired wet paint film thickness; and

(c) a means for maintaining a substantially constant volume of paint in the pool.

Preferably the metering means is a metering roll.

In an alternative, although not the only other, embodiment the metering means is a metering blade.

According to the present invention there is also provided an apparatus for forming a coating of a paint composition on a substrate in accordance with the method described above, which apparatus includes:

(d) a roll coater assembly which includes:

(j) an applicator roll mounted to contact the substrate;

(ii) a metering roll mounted in relation to the applicator roll to form a nip between the rolls;

(iv) a means for applying pressure to rolls to maintain the rolls in contact at the nip;

(e) a means for supplying the paint composition to a pool of the paint composition that is confined at least in part by the nip between the rolls at a volume flow rate that is substantially the same volume flow rate as that required to form a coating of a desired wet paint film thickness; and

(f) a means for maintaining a substantially constant volume of paint in the pool.

Preferably the means for maintaining the substantially constant volume of paint in the pool includes a means for adjusting any one or more of the surface speed of the applicator roll, the surface speed of the metering roll, the substrate speed, and the contact pressure between the rolls.

More preferably the roll speeds, the substrate speed, and the pressure between the applicator roll and the substrate are held constant during painting and the primary means for maintaining the substantially constant volume of paint in the pool is a means for adjusting the pressure between the applicator roll and the metering roll.

Preferably the means for maintaining the substantially constant volume of paint in the pool includes a means for monitoring the level of the paint composition in the pool.

Preferably the apparatus further includes a means for controlling the maximum surface speed of the metering roll expressed as a percentage of the applicator roll speed to be a linear relationship with the applicator roll speed so that the applicator roll speed of the metering roll is no more than 1.2% of the applicator roll speed at an exemplary low applicator roll speed of 15 meters per minute and no more than 12% of the applicator roll speed at an exemplary applicator roll speed of 150 meters per minute.

Preferably the apparatus further includes side dams that further confine the pool for the paint composition.

The present invention is described further with reference to the accompanying drawings, of which;

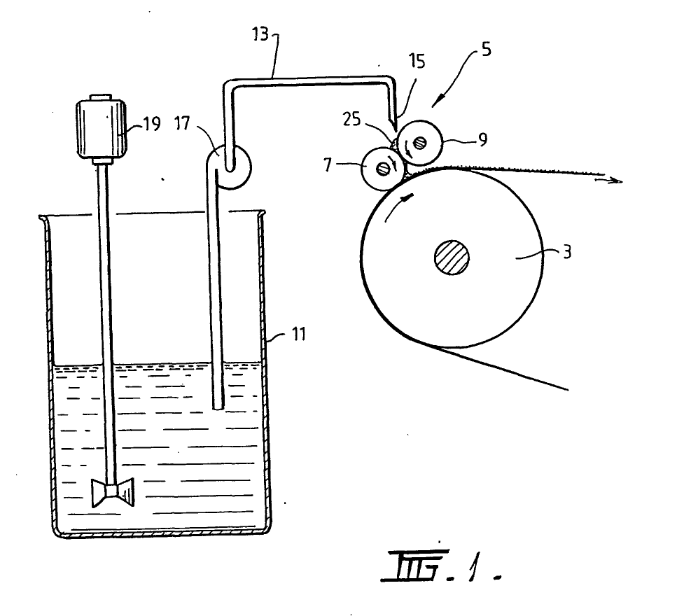

FIG. 1 is a diagrammatic sectional side elevation of a preferred embodiment of a coating apparatus in accordance with the present invention;

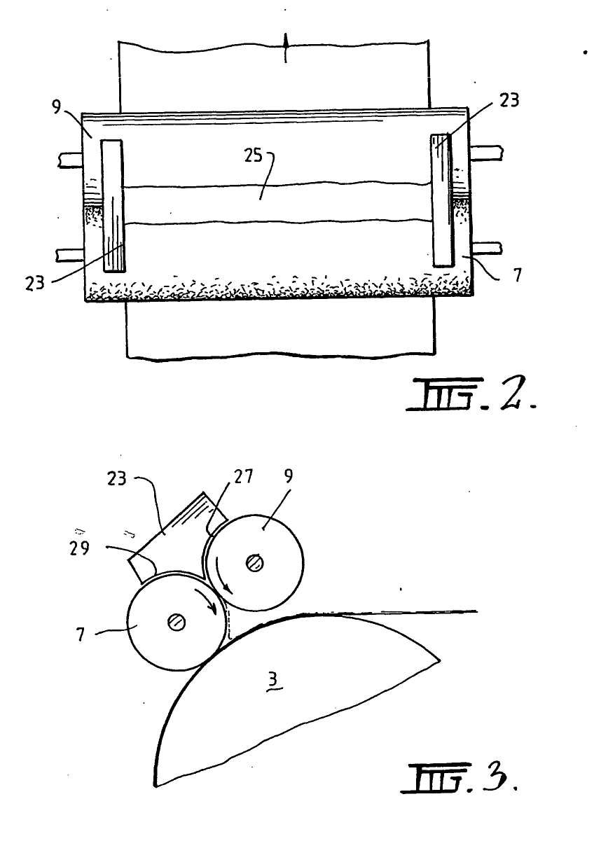

FIG. 2 is a top plan view of one embodiment of the roll coater assembly that forms part of the apparatus shown in FIG. 1;

FIG. 3 is a side elevation of the roll coater assembly shown in FIG. 2;

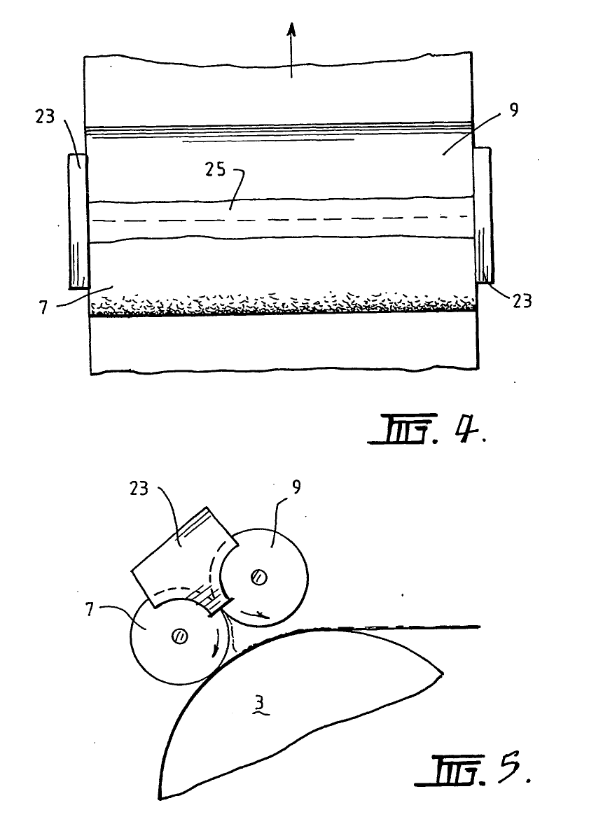

FIG. 4 is a top plan view of another embodiment of the roll coater assembly that forms part of the apparatus shown in FIG. 1;

FIG. 5 is a side elevation of the roll coater assembly shown in FIG. 4;

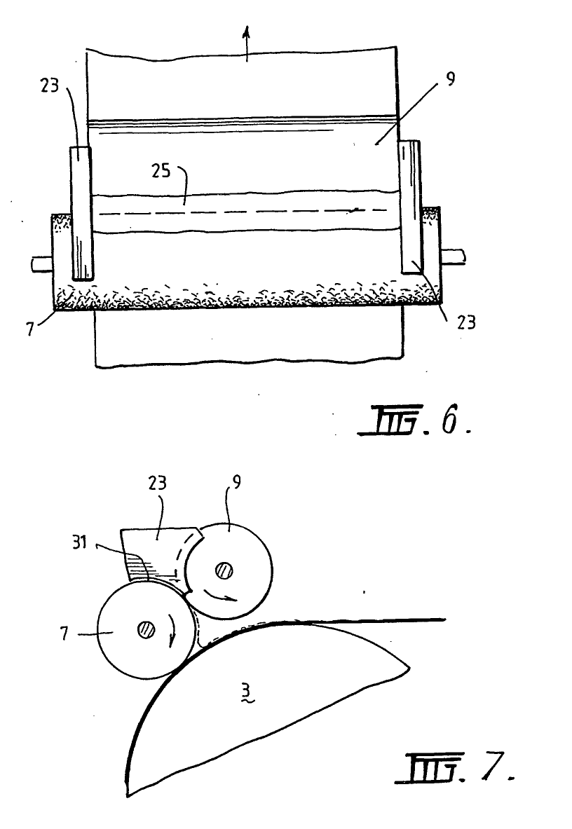

FIG. 6 is a top plan view of another embodiment of the roll coater assembly that forms part of the apparatus shown in FIG. 1; and

FIG. 7 is a side elevation of the roll coater assembly shown in FIG. 6.

The following description is in the context of forming a coating of a polymer-based paint composition on a substrate in the form of a steel strip. The present invention is equally applicable to other types of paints and other types of substrates.

With reference to FIG. 1, a steel strip 1 which is to be continuously painted on one surface with the paint composition is caused to travel around an idler roll 3 and past a roll coater assembly, generally identified by the numeral 5, that forms part of the preferred embodiment of the coating apparatus of the present invention.

The coating apparatus shown in FIG. 1 forms part of a paint coating line. The paint coating line may be an integral, final part of a continuous galvanising line or may be fed from a conventional uncoiler (not shown) that is loaded with a coiled strip from stock and the coiled strip may undergo many other processing stages after uncoiling including but not limited to chemical or mechanical cleaning, chemical surface treatment, coating with layers of corrosion inhibiting coatings whether said layers (coatings) are organic or inorganic in nature, priming with an organic coating including thermal or other form of curing of said primer, optionally quenching and further drying.

The coater assembly 5 applies a thin coating of the paint composition in a liquid form onto the surface of strip 1. Preferably the still wet, or still uncured coating, is 12 to 50 microns thick.

The coater assembly 5 includes a rubber-coated applicator roll 7 that is mounted to contact the substrate, a steel metering roll 9 mounted in relation to the applicator roll 7 so that there is a nip between the rolls 7, 9, and a means (not shown) for applying pressure to the rolls to maintain the rolls in contact at the nip. In another embodiment the metering roll 9 has a rubber outer layer.

The rolls 7, 9 are mounted to rotate in the directions indicated by the arrows in the Figures.

The metering roll 9 and the applicator roll 7 are driven rolls. The applicator roll 7 is driven at a surface speed that is within plus or minus 20% of the strip speed.

The coater assembly 5 further includes side dams 21 (not shown in FIG. 1 but shown in FIGS. 2-7) which cooperate with the nip between the rolls 7, 9 and the upper sections of the rolls 7, 9 to confine a pool 25 of the paint composition.

FIGS. 2-7 illustrate three configurations of the side dams 23. In the configuration shown in FIGS. 2 and 3 the side dams 23 are positioned inwardly of the ends of the rolls 7, 9 and thereby confine the width of the pool 25 to be less than the width of the rolls 7, 9. As can best be seen in FIG. 3, the side dams 23 are shaped to included curved surfaces 27, 29 that conform to the curved surfaces of the rolls 7, 9. Such substantial conformance may be provided by designing at least one surface of the side dam to be flexible by incorporation, or manufacture using a deformable substance. Such deformable side dam surface will substantially be in contact with the rubber covered applicator roll 7. In the configuration shown in FIGS. 4 and 5 the side dams 23 are positioned against the ends of the rolls 7, 9 so that the width of the pool 25 is the same as the width of the rolls 7, 9. In the configuration shown in FIGS. 6 and 7 the width of the metering roll 9 is less than that of the applicator roll 7 and the side dams 23 are positioned against the ends of the metering roll 9 and are shaped to include a curved surface 31 that conforms to the curved surface of the applicator roll 7 and contacts that surface. In another, although not the only other possible, configuration (not shown), the width of the applicator roll 7 is less than that of the metering roll 9 and the side dams 23 are positioned against the ends of the applicator roll 7 and are shaped to include a curved surface that conforms to the curved surface of the metering roll 9 and contacts that surface.

The side dams 23 may be formed from any suitable material, such as a plastics material. They may incorporate a foam, a felt, a cloth, a sponge, or an elastomer.

The coating apparatus shown in FIG. 1 further includes a drum 11 that contains a volume of the paint composition, a stirrer assembly 19 that stirs the paint in the paint drum 11, and a line 13 that extends from the paint drum 11 and has an outlet end 15 that is positioned above the nip between the rolls 7, 9. A paint spreading means (not shown) may optionally be placed at the outlet end 15.

The coating apparatus further includes a pump 17 that pumps the paint composition from the paint drum 11 through the transfer line 13 to the nip between the rolls 7, 9. In accordance with the present invention the pump 17 is selected to provide accurate control over the flow rate of the paint composition to the nip 7, 9. Suitable pumps 17 include peristaltic and gear pumps.

Unlike the conventional roller coater assembly described above, the coater assembly 5 shown in FIG. 1 does not include a chute for returning the paint composition to the paint drum 11. It is noted that it is within the scope of the present invention to provide such a chute for unexpected overflow situations or to remove small volumes of waste paint that may leak past the side dams 23 or may leak in the vicinity of the nip in a region in approximate alignment with the strip edges. Alternatively, a tray may be used to collect such paint wastage.

In use of the above-described coating apparatus, under steady-state operating conditions, the pump 17 pumps the paint composition from the paint drum 11 through the line 13 to the pool 25 confined by the nip between the rolls 7, 9 and the side dams 23. The rolls 7, 9 rotate in the directions of the arrows shown in the Figures, with the result that paint composition from the pool 25 is carried by the rolls 7, 9 through the nip. The paint composition carried by the metering roll 9 is returned to the pool 25. The paint composition carried by the applicator roll 7 is carried to and brought into contact with the steel strip 1 and is transferred to the steel strip 1 and forms the coating on the steel strip 1. The flowrate of the paint composition from the paint drum 11 is controlled by the pump 17 to be substantially equal to the paint flow rate required to achieve a desired target wet paint film thickness across the entire surface of the substrate being painted with due consideration being given to the strip speed, the strip width, and the paint wastage rate as these factors are fundamental in determining the required paint volume flow rate.

One suitable flow rate formula would be as follows:

Paint flow rate into the nip (cubic metres/minute)=Target wet film build(metres)×strip width (metres)×strip speed (metres/min)+paint wastage (cubic metres/minute)

Preferably very soon after or immediately after the start of painting, i.e., once the applicator roll has been brought into full and operational contact with the moving substrate, any or a combination of the operating parameters of the coating apparatus is adjusted in order to achieve a substantially constant volume of paint in the nip region between rolls 7, 9. Optionally, a sensor (not shown) may be used to monitor the volume or level of paint in said nip region. Optionally, said monitor may be connected via a control system or a signal generation system to control any or a combination or all of the operating parameters of the coating apparatus in order to provide automatic control of the coating system. Note: the steady state flow rate of paint may be established by a flow rate controlling valve, if a pump is not used, or in conjunction with a pump. A flow rate monitor may also be incorporated at any suitable part of the coating apparatus.

Preferably the metering roll 9 is driven to rotate slowly relative to the speed of the applicator roll 7 to produce a high shear rate which minimises paint ribbing of the paint finish on the strip. This is a considerable advantage as the smoothness performance typical of a three roll paint coater may be achieved using the two roll paint coater of the present invention. Moreover, it is an advantage that is not possible with the conventional two roll coater paint applicator described above.

In commercial metal strip continuous painting lines the strip speed may typically be within the range of 15 to 200 meters per minute. Preferably the metering roll 9 is driven so that the surface speed of the roll 9 is no more than 1.2% of the applicator roll speed of 15 meters per minute and the roll speed increases linearly to be no more than 9.6% of the applicator roll speed at 120 meters per minute. This would place corresponding maximum roll surface speeds for the metering roll 9 within the range of 0.18 to 11.52 meters per minute. More preferably the metering roll 9 is controlled to less than 1% of the applicator roll speed.

One suitable procedure for starting up the above-described steady-state coating method includes an initial step of bringing together the rolls 7, 9 in a “set-up” position that is spaced from the strip 1. The rolls 7, 9 are brought together with a contact pressure that is selected to be close to that nominally required to produce the required wet paint film thickness of coating on the steel strip 1. Thereafter, the pump 17 is operated to pump the paint composition from the paint drum 11 via the transfer line 13 to establish the pool 25 of the paint composition. When, or before the pool 25 reaches a predetermined volume, rotation of the applicator roll 7 and the metering roll 9 is commenced while the coating assembly 5 is moved into an operative position, as shown in FIG. 1, in which the applicator roll 7 contacts the moving steel strip 1. Any one or more of the operating parameters of the coating apparatus, such as the surface speed of the applicator roll 7, the surface speed of the metering roll 9, the substrate speed (but preferably not the substrate speed), the contact pressure between the applicator roll and the steel strip, and the contact pressure between the applicator roll 7 and the metering roll 9, are adjusted to maintain the level and hence the volume of the paint in the pool to be substantially constant. More preferably the only operating parameter which is adjusted to maintain the level and hence the volume of the paint in the pool to be substantially constant is the pressure or position between the applicator roll 7 and the metering roll 9.

One suitable procedure for shutting down operation of the above-described coating method includes an initial step of stopping supply of the paint composition from the paint drum 11 to the pool 25. As soon as the paint in the pool diminishes to the extent that a complete paint coating is no longer being formed on the substrate, and while the steel strip 1 continues to be moved past the coating assembly 5, the contact pressure between the rolls 7, 9 is quickly reduced to allow increased flow of paint composition from the pool 25 onto the steel strip 1 to quickly eliminate the bulk of residual paint on the applicator roll. Soon therafter, the coating assembly 5, and particularly the applicator roll 7 is moved away from the steel strip. This procedure may be adopted to assist in very quick clean up of the coating apparatus.

The present invention is not limited to the descriptions for start up and shut down procedures presented in this specification. For example, the shut down procedure may be simply to stop the flow of paint to the pool, followed by removal of the coating assembly off the substrate, followed by dumping of the residual paint pool and cleaning the coating assembly in the usual way.

Alternative start up procedures might include wetting the rolls 7,9 with a non-contaminating liquid to lubricate the rolls prior to introduction of paint to the pool 25. It may involve waiting to pump additional paint into the pool once painting has commenced using an initial volume of paint in an initial pool.

Many modifications may be made to the preferred embodiment of the present invention as described above without departing from the spirit and scope of the present invention.

By way of example, whilst the preferred embodiment includes a metering roll 9 that forms part of the described coating assembly, it can readily be appreciated that the present invention is not limited to such an arrangement and extends to other suitable metering means, such as a metering blade.

What is claimed is:

1. A method of forming a coating of a paint Composition on a substrate which includes the steps of:
(a) moving the substrate past an applicator roll while maintaining contact between the applicator roll and a substrate and rotating at least the applicator roll and optionally a metering roll in contact with the applicator roll so that the paint composition is carried by the applicator roll through a nip between the applicator roll and the metering roll and into contact with the substrate and forms a coating on the substrate;
(b) supplying the paint composition in liquid form into a pool of the paint composition in the nip between the rolls at a controlled volume flow rate that is substantially equal to the volume flow rate that is required to achieve a desired target wet paint film thickness on the substrate; and
(c) maintaining the level and hence the volume of the paint in the pool to be substantially constant.

2. The method defined in claim 1 wherein step (b) includes rotating the applicator roll and the metering roll so that the applicator roll carries the paint composition into contact with the substrate in a direction that is opposite to the direction of movement of the substrate.

3. The method defined in claim 1 wherein step (b) includes rotating the applicator roll and the metering roll so that the applicator roll carries the paint composition into contact with the substrate in the same direction as the direction of movement of the substrate.

4. The method defined in any one of the preceding claims wherein the metering roll and the applicator roll are driven at controlled speeds.

5. The method defined in any one of the preceding claims wherein step (c) of maintaining the level and hence the volume of the paint composition in the pool at a substantially constant level includes adjusting any one or more of the substrate speed, the surface speed of the applicator roll, the surface speed of the metering roll, the contact pressure between the applicator roll and the substrate, and the contact pressure between the applicator roll and the metering roll.

6. The method defined in any one of the preceding claims further includes controlling the maximum surface speed of the metering roll expressed as a percentage of the speed of the applicator roll to be a linear relationship with the applicator roll speed so that the surface speed of the metering roll is no more than 1.2% of the applicator roll speed at an exemplary low applicator roll speed of 15 meters per minute and no more than 12% of the applicator roll speed at an exemplary applicator roll speed of 150 meters per minute.

7. The method defined in claim 6 includes controlling the maximum surface speed of the metering roll expressed as a percentage of the applicator roll speed to be less than 1% of the applicator roll speed.

8. The method defined in any one of the preceding claims includes controlling the speed differential between the metering roll and the applicator roll to ensure that the paint composition carried by the metering roll from the pool constitutes a film on the metering roll having an average thickness of no more than two microns.

9. The method defined in any one of the preceding claims wherein the substrate is a metal strip.

10. The method defined in any one of the preceding claims includes positioning side dams in relation to the applicator roll and the metering roll to confine the pool.

11. An apparatus for forming a coating of a paint composition on a substrate in accordance with the method defined in any one of the preceding claims, includes:
(a) a roll coater assembly which includes:
(i) an applicator roll mounted to contact the substrate;
(ii) a metering roll mounted in relation to the applicator roll to form a nip between the rolls;
(iii) a means for applying pressure to rolls to maintain the rolls in contact at the nip;
(b) a means for supplying the paint composition to a pool of the paint composition that is confined at least in part by the nip between the rolls at a volume flow rate that is substantially the same volume flow rate as that required to form a coating of a desired wet paint film thickness; and
(c) a means for maintaining a substantially constant volume of paint in the pool.

12. The apparatus defined in claim 11 wherein the means for maintaining the substantially constant volume of paint in the pool includes a means for adjusting any one or more of the substrate speed, the surface speed of the applicator roll, the surface speed of the metering roll, the substrate speed, and the contact pressure between the rolls.

13. The apparatus defined in claim 12 wherein the means for maintaining the substantially constant volume of paint in the pool includes a means for monitoring the level of the paint composition in the pool.

14. The apparatus defined in any one of claims 11 to 13 further includes a means for controlling the maximum surface speed of the metering roll expressed as a percentage of the applicator roll speed to be a linear relationship with the applicator roll speed so that the applicator roll speed of the metering roll is no more than 1.2% of the applicator roll speed at an exemplary low applicator roll speed of 15 meters per minute and no more than 12% of the applicator roll speed at an exemplary applicator roll speed of 150 meters per minute.

15. The apparatus defined in any one of claims 11 to 14 further includes side dams that further confine the pool for the paint composition.

16. A method of forming a coating of a paint composition on a substrate which includes the steps of:
(a) moving the substrate past an applicator roll while maintaining contact between the applicator roll and the substrate and rotating the applicator roll so that the paint composition is carried by the applicator roll through a nip between the applicator roll and a metering means that is in contact with the applicator roll and into contact with the substrate and forms a coating on the substrate;
(b) supplying the paint composition in liquid form into a pool of the paint composition in the nip between the applicator roll and the metering means at a controlled volume flow rate that is substantially equal to the volume flow rate that is required to achieve a desired target wet paint film thickness on the substrate; and
(c) maintaining the level and hence the volume of the paint in the pool to be substantially constant.

17. A method of forming a coating of a paint composition on a substrate which includes the steps of:
(a) supplying the paint composition in liquid form to a nip between a metering roll and an applicator roll of a coater assembly and establishing a pool of the paint composition in the nip;
(b) prior to, during, or after step (a), bringing the applicator roll into contact with the substrate;
(c) moving the substrate past the applicator roll while maintaining contact between the applicator roll and the substrate and rotating at least the applicator roll and optionally the metering roll so that the paint composition is carried by the applicator roll through the nip between the rolls and into contact with the substrate and forms a coating on the contact surface of the substrate;
(d) as the paint composition is being removed from the pool by step (c) supplying the paint composition in liquid form into the pool at a controlled volume flow rate that is substantially equal to the volume flow rate required to achieve a desired target wet paint film thickness on the substrate taking into consideration the strip width, and the strip speed; and
(e) adjusting any one or more of the surface speed of the applicator roll, the surface speed of the metering roll, the substrate speed, the contact pressure between the applicator roll and the substrate, and the contact pressure between the applicator roll and the metering roll to maintain the level and hence the volume of the paint in the pool to be substantially constant.

18. An apparatus for forming a coating of a paint composition on a substrate in accordance with the method defined in any one of claims 1 to 10, 16 and 17, which apparatus includes:
(a) a roll coater assembly which includes:
(i) an applicator roll mounted to contact the substrate;
(ii) a metering means mounted in relation to the applicator roll to form a nip with the applicator roll;
(iii) a means for applying pressure to the applicator roll and the metering means to maintain the roll and the metering means in contact at the nip;
(b) a means for supplying the paint composition to a pool of the paint composition that is confined at least in part by the nip between the applicator roll and the metering means at a volume flow rate that is substantially the same volume flow rate as that required to form a coating of a desired wet paint film thickness; and
(c) a means for maintaining a substantially constant volume of paint in the pool.
